(19) United States
(12) Patent Application Publication
(10) Pub. No.: US 2016/0363935 A1
(43) Pub. Date: Dec. 15, 2016

(54) SITUATIONAL AND PREDICTIVE AWARENESS SYSTEM

(71) Applicants: Gary SHUSTER, Fresno, CA (US); David GOLDSMITH, Manlius, NY (US)

(72) Inventors: Gary SHUSTER, Fresno, CA (US); David GOLDSMITH, Manlius, NY (US)

(21) Appl. No.: 15/183,724

(22) Filed: Jun. 15, 2016

Related U.S. Application Data
(60) Provisional application No. 62/175,979, filed on Jun. 15, 2015.

(51) Int. Cl. G05D 1/00; G01C 21/36; H04L 29/06; B60L 7/10; B60R 16/023; H04L 29/08; G01C 21/34; G08G 1/0967

(52) U.S. Cl. CPC G05D 1/0088; G01C 21/3484; G01C 21/3697; G08G 1/0967; B60L 7/10; G01C 21/3658; B60R 16/0231; H04L 67/12; H04L 63/10; H04L 63/0861

(57) ABSTRACT

Vehicles, including autonomous vehicles, which receive external data from sources other than the sensors on the vehicles, analyze such external data and alter the driving behaviors of the vehicles based on the external data are disclosed. External data may be gathered from other vehicles, news feeds, social networking posts or may comprise data about previously observed behaviors of other vehicles or drivers. Such external data may include locations of and/or information regarding other vehicles, traffic signs and or signal lights, on or off ramps, road hazards, road conditions, traffic conditions, vehicular or pedestrian congestion, etc. In other aspects, systems for adjusting vehicle settings based on driver preferred settings are disclosed.

### CROSS-REFERENCE TO RELATED APPLICATIONS

This application claims the benefit of U.S. Provisional Patent Application No. 62/175,979 filed Jun. 15, 2015. The text and contents of this provisional patent application is hereby incorporated into this application by reference as if fully set forth herein.

### FIELD OF INVENTION

The present invention generally relates to the field of self-driving vehicles. More specifically, embodiments of the present invention pertain to systems to adjust vehicle settings and vehicle driving behavior based on sensor data gathered from sources external to the vehicle and/or driver preferences.

### DISCUSSION OF THE BACKGROUND

Vehicles are increasingly computerized, sensor-equipped, and telecommunications-equipped. Despite this, vehicular operation, routing and available data remain relatively unsophisticated. Vehicles are frequently equipped with a memory and/or a method for reading removable media (such as music files on a flash drive). Yet, vehicles remain primarily autonomous, acting independently from each other, rather than acting as cooperative nodes.

### SUMMARY OF THE INVENTION

As self-driving vehicles become more common, and as additional sensors are added to vehicles, combined with the new connectivity options such as 4G and LTE connectivity that vehicles possess, as well as Bluetooth connections to other devices such as transmission capable handheld devices like the iPhone, vehicles have access to communications modalities and data that allow a very accurate prediction of traffic patterns and behavior.

In one aspect, there is a centralized server (although in certain aspects the invention may also utilize a peer-to-peer, cloud, local server or data processing modality) that tracks vehicles by identifying information, such as unique markings on the vehicle, license plates, facial recognition of drivers (which would then be driver dependent and not vehicle dependent), a combination of driver and vehicle identification, so that the driver who drives differently in their work truck from the way they drive in their sports car can be treated appropriately, and shared characteristics across both vehicles noted. Similarly, vehicles with different drivers may be tracked, and similarities, such as an inability to quickly start from a temporary stop (e.g., a stop sign or red light) may be noted, and differences that are driver dependent also noted.

In one aspect, most vehicles have backup cameras. The data feed from the backup camera may be utilized, in one aspect in conjunction with image recognition software, to generate a video composite of the cars on the road, road conditions, and other factors. As additional sensors become available, such as site scan radar, sonar, front facing cameras, side facing cameras, and even the activation of a back facing camera on a cell phone being mounted in a car, or held to a passenger's ear, data from those sensors may be incorporated as well.

As this data is coordinated and analyzed, a quite complete picture of road conditions may be generated, and this picture would be valid, in sufficiently populated traffic conditions for tens or even hundreds of miles.

Taking as an example a driver who is going to drive from San Francisco to Los Angeles, and would like to choose between going through Fresno and taking the 99 freeway, taking the 101 freeway, and taking the 5 freeway, the driver may be able to input preferences. For example, “please find me a route where there is a vegetarian restaurant on the way.” Another option may be “please find a route with a minimum number of commercial trucks”, “find a route where the road condition, such as paving and potholes, meets certain minimums”, or “find a route where there is a minimal risk of gravel being thrown up in the air and hitting the car as a projectile”. The preferences may be input verbally, by typing on a device attached to the vehicle, on a route planning app on a device that communicates with the vehicle, or otherwise.

It should be understood that unless the context clearly requires otherwise, a reference to “driver” may include a human driver present in the vehicle, a remotely located driver directing the vehicle, a semi-autonomous vehicle, or a fully autonomous vehicle.

In another aspect, the data from other vehicles may be utilized to capture the most recently observed road sign, meeting certain characteristics. Thus, for example, the three most recent caution signs, the two most recent speed limit signs, the most recent off-ramp signs, may all be captured and displayed. Such display may optionally be made in conjunction with a distance and/or time measurement. Thus, for example, the display may show speed limit 70, warning speed limit 55 ahead, and speed limit 55. The first of those signs may show 5 miles, the next ratio one-mile and the one after that may show 0.8 miles. This way, the driver can identify the validity or likely validity of the data on the signs. For example, if the driver is in the leftmost lane and a truck is between the driver and the speed limit sign, the vehicle may miss imaging the speed limit sign. In a preferred implementation, the data about the sign may be gathered from another vehicle and transmitted to the subject vehicle. However, knowing that the last time the speed limit sign was imaged was 15 miles earlier may serve as an indicator to the driver that the speed limit quite likely may have changed, as speed limit signs normally appear more frequently than every 15 miles. In addition, different categories of signs may be identified and treated differently. For example, the most recent speed limit sign, most recent off-ramp sign, and most recent “services ahead” sign may all be retained and displayed and/or the data on the sign presented.

In another aspect, it is very important for hybrid electric vehicles, electric vehicles, and even (for purposes of fossil fuel efficiency for internal combustion engine vehicles, sometimes referenced herein as “ICE”) to identify when the vehicle needs to stop. In particular, where the vehicle possesses the ability to capture some of its forward momentum in the form of energy, such as regenerative braking, simply knowing that you will need to stop in time for a stop sign 50 yards away would allow you to stop at a distance that creates optimal fuel efficiency. For example, taking the Tesla model S, that vehicle has a very strong regenerative braking system. If the driver lets off the accelerator in that vehicle, it slows to a speed of two or 3 mph from a speed of 40 mph in perhaps 100 or 200 feet. In such a case, imagining for the sake of discussion that a vehicle traveling 40 miles an hour has the optimal regenerative energy recapture if acceleration ceases two hundred feet prior to the stop point, it would be incredibly useful to know that the vehicle currently stopped at a light that is soon to turn green always takes five or more seconds to start up. In such a case, the vehicle would come to a complete stop even after the light had turned green, because the vehicle ahead of it starts slowly from a dead stop. Accordingly, optimal stopping for energy efficiency would require a cessation of acceleration at 200 feet away from the back of that vehicle. If, on the other hand, there is no vehicle waiting at the light, or the vehicle waiting at the light typically starts and 500 milliseconds from the light changing color, as the subject vehicle approaches the light, it may simply use the distance from the light, and data (potentially gathered from ambient cameras, sensors, sensors on other vehicles, or otherwise) to determine how long it will be before the now red light turns green. In one implementation, side scan detection would cause emergency braking if it appeared that a vehicle was going to run through the red light in their direction. Alternatively, a built-in delay, such as one second, may be used before passing through the intersection, so braking may be delayed so that the light would have a chance to be green for a certain amount of time for safety or other reasons. It should be noted that optimal delay times may vary based on one or more factors, such as vehicular characteristics, driver reaction time (which time may be tested or inferred and used as a basis for the mode or timing of implementation of any of the inventions herein), location, intersection characteristics, time of day, lighting conditions, weather conditions, or other factors. A delay of anywhere between 0 and 5,000 milliseconds may be reasonable depending on the various factors.

In one implementation, there are cameras and/or other sensors inside the vehicle, and they image the hand motions or other motions of the driver. The driver may simply point at an object and say stop. In such a case, the vehicle would calculate when it is appropriate to begin deceleration, and decelerate in a manner that maximizes recapture of energy. For non-regenerative braking vehicles such as ICE vehicles, information as to the speed with which traffic will move further ahead may be utilized to prevent unnecessary fuel consumption as part of acceleration. Whether regenerative or not, it is preferable for fuel efficiency that the vehicle not accelerate more than is necessary to get to a place where the vehicle or object or street sign had required them to stop for a fixed period of time or at a fixed period of time. In another aspect, the driver may speak to a voice recognition unit associated with the vehicle to inform the vehicle of his intentions. For example “Kitt, we are going to turn right on 4^{th} Street”, which would allow the vehicle to initiate braking at the appropriate distance, signal a turn, advise that braking commence, or take other actions. In one aspect, vehicular features such as turn signals may be actuated via verbal commands.

In another aspect, markings on the street related to switches associated with triggering changes to lights may be identified using a database, cameras, sensors, manual identification, or other mechanisms. Where the switches appear to not be actuated (such as when there is no vehicle waiting at a light as the user's vehicle approaches), the timing of the vehicle approach may be altered in order to speed triggering of the switches. For example, while a vehicle may normally initiate regenerative braking at 200 feet from the intersection, where the light is red and there is nobody at the intersection, regenerative braking may be initiated at 100 feet in order to more rapidly trigger the switches. In one aspect, the user's calendar may be accessed in order to determine whether the user is in transit to an appointment. If so, the vehicle may be more aggressive in rapidly triggering the switches based on the likelihood that the user will arrive late to the appointment. Similar timing changes may be triggered by approaching weather or lighting changes.

The cameras and/or sensors may also be utilized to measure response time of the driver, analyze whether the driver is distracted, identify whether the driver is paying attention to the road, or other factors. The vehicle may respond appropriately, such as by warning the driver, automatically slowing the vehicle, making auto-braking more aggressive or otherwise.

In one aspect, a diagram, or actual images, of the surrounding area may be utilized to improve driver situational awareness, fuel efficiency, and other factors. For example, if it is observed that the driver 100 yards distant has license plate number 555-1212, and associated with that license number is data indicating that such driver typically drives 15 miles an hour under the speed limit, the system may suggest routing on streets to go around the driver, may warn that the proper lane to be in is a different lane than the slow driver, or may otherwise pass the data and its implications on to the driver.

These inventions may be integrated with a global positioning system display, and may also be integrated with traffic displays that are incorporated into certain GPS displays. This may also be used to supplement the data on a GPS display. For example, utilizing Google's traffic methodology, the relative speeds of Internet connected devices reporting to Google's servers are utilized to determine traffic speed along certain roads. Traffic speed between zero and a very low number are displayed in red, more moderate speeds are displayed in yellow, and traffic traveling at slightly below, or above the speed limit may be displayed in green. One might implement a system where slow-moving cars or other vehicles that are associated with hazards generate a flashing red circle or other shade indicating their presence, their direction, their speed, and/or some combination of other data. Returning to our example of the slow-moving driver with the 555-1212 license, as a driver moves down a three lane road that is crowded, the driver may be in the leftmost lane, and may receive a warning that a slow-moving car is in the leftmost lane, and according to past data has a 25% chance of moving to the middle lane in the next 2 miles and a 1% chance of moving to the far right lane in the next 2 miles, so may recommend that the driver move to the middle lane and be prepared to move to the left lane again if the driver moves into the middle lane.

In one aspect, it will be useful to identify vehicles with multiple drivers. For example, the 555-1212 license car may be operated by Joe or Jill. In one aspect, the identity of the driver may be determined, with some level of confidence, based on driving patterns. In such a case, it may not be necessary for the system to identify the actual driver, but may simply be enough for it to identify that it is driver one or driver two. In another aspect, imaging may be utilized to determine the identity of the driver. For example, the rear view camera on the vehicle ahead of the target vehicle may image the driver. In another aspect, by imaging the non-driver, such as the passenger, the person in the passenger seat may be ruled out as a potential driver.

In another aspect, dangerous driving habits may be stored and/or utilized by the system. For example, imagine a driver with the license “Deuce”. That driver is known to have three DUI convictions. Camera data and side scan radar data from vehicles ahead of our vehicle detect that the Deuce vehicle is hugging one of the sides of the lane, and is roving slightly back and forth, indicating the likelihood that the driver is intoxicated. Even without the data on the DUI convictions, the vehicle may create a warning that the Deuce vehicle is likely driven under the influence. In such a case, appropriate evasive maneuvers may be recommended, such as changing lanes, slowing down, taking an alternate route, or otherwise. In addition, law enforcement reporting may be made. The reporting may be made in an automated manner. In one aspect, the vehicle may then be tracked utilizing the sensor data from various other vehicles, in one aspect at the request of police, in another aspect based on a search warrant, or in another aspect simply based on preferences built into the system.

In one aspect, a heuristic or other artificial intelligence system may be utilized to analyze driver behavior. For example, driver behavior leading up to an arrest for driving under the influence (or we may use actual convictions rather than simple arrests, or combination thereof) may be fed into the system in order to develop a profile of driving behaviors that are associated with driving under the influence arrests. In this way, drivers that were under the influence may be differentiated from drivers that were distracted, driving recklessly, texting, or engaging in other behaviors. In another aspect, behaviors that are indicative of such driver conditions may be manually programmed into the system (either alone or in combination with artificial intelligence derived data).

In a simple implementation, GPS directions, such as “exit road N 2 miles ahead on the right” may be modified based on forward-looking traffic conditions, as measured by this system. Thus, for example, if there is a vehicle traveling hideously slowly in the far right lane, and a road hazard in the middle lane, our vehicle may be instructed to stay in the left lane until they have passed the road hazard then move to the middle lane until they pass the slow-moving vehicle, and then move over to the right.

In another aspect, road debris or other hazards, such as potholes may be automatically reported to appropriate authorities, may be flagged on GPS systems, or may otherwise be shared. In one aspect, imaging sensors may capture one or more images of the road hazard. Such images may be uploaded to the Department of Motor Vehicles or some other entity capable of initiating repairs or cleanup.

In an even simpler implementation, it may be useful simply to provide images, similar to clicking on the little picture icons on Google maps, that allows drivers to click on their GPS and see a live image of the road at that point, probably captured by the imaging sensors on another vehicle, stationary cameras, and/or cameras mounted on portable devices.

In one aspect, data persistence may be introduced between vehicles and between uses of the same vehicle. For example, a USB key may be inserted into a USB port in a vehicle, and the user's favorite radio stations, GPS destinations, distance between seat and steering wheel, lumbar support adjustment, garage door codes, and/or other settings may be stored. Upon entry into a different vehicle, one or more of these settings may be exported to the vehicle and/or read directly from the USB key (it should be appreciated that while we reference USB key, it may be any memory operably coupled with the vehicle, including NFC and other connections with mobile devices; similarly, “inserted” should be understood as “operably connected” when the context requires). In one implementation, a password or access code may be required to access the settings. In another implementation, the settings may only remain valid so long as the USB key remains inserted. In another implementation, the settings may be transient for a vehicle that is not the vehicle where the settings were originated. In another implementation, it may be transient for every vehicle, and require insertion of the USB key within some time frame to prevent expiration. Expiration may be immediate, or delayed. In another implementation, the data may be associated with a face, fingerprint, or other biometric data and that data read to validate utilization of the data. In one aspect, the data on the USB key may be encrypted against the biometric data. Alternatives exist to the use of a USB stick. In one aspect, a rental car company may have data persistence based on renter identity, preferentially give the renter vehicles with identical or similar driving profiles, and/or may cause the vehicles to be configured similarly based on past driver settings. Similarly, database systems in combination with Internet or other network connectivity may be utilized, optionally in conjunction with account sign in, to provide data persistence.

In one aspect, observed driving behaviors may be stored. For example, if a driver with the license plate ABC 123 is frequently observed exceeding the speed limit by a significant amount, it may be inferred that they have experience driving at high speeds. Similarly, if 10 hours of driving of the vehicle ABC 123 are captured, and the vehicle never exceeds 45 mph in any of those 10 hours, it may be inferred that the driver is likely to have little or no experience in driving at high speeds and/or is uncomfortable with driving at such speeds. Thus, we can use this gather data for various purposes, such as providing an appropriate warning for the primary driver that the vehicle ABC 123 is being operated by someone without adequate experience at high speeds. Similarly, such data may be aggregated, and utilized in aggregate form to adjust insurance rates for an area, recommend changes to policing practices or policing frequency, changes to speed limits, changes to traffic control systems, defensive or other driving alterations for autonomous vehicles or semi-autonomous vehicles, and other factors. Similarly, individual data may be utilized to make various determinations. In one aspect, a rental car company may utilize driving history of a potential renters primary vehicle, or, if facial recognition is utilized, may simply use driving behavior of the potential driver directly, and may use it to determine whether they will rent to that person, and if so, whether they require additional insurance, have to pay an additional security deposit, have to pay for a higher risk rate, or otherwise. This data can be coordinated with public information such as databases of convictions for traffic violations and alcohol or drug violations.

One event that occurs frequently is that traffic will form into clumps. While there are various explanations as to the cause, it may be useful to provide guidance to drivers as to which lanes, and which routes, contain other drivers who roughly match the primary drivers driving preferences. Thus, for example, if there is a four-lane freeway and the fast lane, number one, is averaging 75 mph with lane number two 70 mph, lane number three 65 mph, and lane number four 55 mph, and the primary driver prefers to drive at 65 mph, the vehicle may indicate to the driver that the optimal lane will be lane number 3. In another aspect, if street traffic on Washington Street is averaging 40 mph with a 35 mph speed limit, and street traffic on Lincoln Street is averaging 45 mph with a 45 mph speed limit, the system may advise a driver who is averse to violating traffic laws that driving down Lincoln Street is preferable. Similarly, a driver who simply wants to be in the fastest traffic may be advised to take Lincoln Street. A driver who is uncomfortable driving on city streets in excess of 40 mph may be advised to take Washington Street. By directing drivers to lanes and routes where the practices of other drivers more closely match their own practices, traffic flow should be improved, reducing traffic clumping and other problems.

In another aspect, drivers may be identified by facial recognition, a database of license plate numbers, data sent, either actively or passively, from devices such as smart phones, or otherwise. Once drivers have been identified, their calendars may be accessed to determine where they are going, how late they are getting there, and other similar factors. Thus, if driver Fred has a meeting at 4 PM, and it is currently five minutes before 4 PM, and the meeting is 5 miles away, it is very likely that Fred will exceed the speed limit, and his vehicle can therefore be flagged as a higher risk vehicle compared to vehicles being operated by people without calendar pressure to speed. Similarly, the place at which a driver originates may be utilized to evaluate risk and, in some cases, likely driving habits. For example, a vehicle that originates at a bar may be flagged as having a higher risk of somebody driving under the influence. Similarly, a vehicle that originates at a school and, where sensor data permits, it is determined that children are in the vehicle, that vehicle may be flagged as low risk for exceeding the speed limit or driving recklessly, and high risk for driving under the speed limit.

In another aspect, the length of time a driver has been driving, together with the number, recency and length of breaks they have taken from driving may be utilized to determine likely driver fatigue. This determination may be utilized to evaluate risk. In addition, once driving habits are established, and once we are able to predict when it is likely that a driver will take a break, we can push advertising, coupons, or simply GPS coordinates to the driver, either via their vehicle mounted device, built-in device, or handheld device. In one aspect, pushing such data may be conditioned upon payment by a third party who would benefit, such as the owner of a restaurant.

The height at which a driver is relative to the other traffic is also a safety factor. If the driver has a lot of experience driving a high vehicle, such as a sport utility vehicle, and has rented a regular sedan, there is a fairly high risk that the driver will not be fully comfortable with the view he is able to establish of other traffic. Based on position of the driver's eyes and/or vehicle type such as bicycles, motorcycles, snowmobiles, and other vehicles relative to other vehicles (e.g., a combination of the drivers height and the height of the vehicle), we can establish a risk score that can be utilized in making driving recommendations or other features of these inventions. Similarly, familiarity with a particular vehicle type (for example, electric, ICE, regenerative braking, multi-axle, etc.) may be utilized.

Such technology, while discussed in the context of motor vehicle traffic, has application as well to boating, trains, aircraft (including those on the tarmac), motorcycles, snowmobiles, bicycles, freight, small boats, freighters, marine traffic, and other means of transportation.

In another aspect, the inventions have application to foot traffic. For example, we may utilize sensors present on handheld phones and other devices, fixed location sensors, vehicular sensors, and other devices to monitor foot traffic in various areas. Pedestrians may have preferences as to what type of walk they prefer. For example, a retired person who is risk-averse may prefer to walk on a relatively empty street, with relatively frequent police presence, even if it takes them out of their way. Similarly, somebody who is always in a hurry and is not adverse to crowds may prefer the fastest route, which would be a combination of distance and pedestrian speed and density. Although it may make little sense to an outsider, pedestrians may also have preferences that are important to them, even if as a general rule their unacceptable to others. For example, a woman may prefer to walk down a street with very few or no men between ages 16 and 40. Similarly, a person with a phobia of dogs may prefer to walk down the street where there are no dogs. These needs may be met by utilizing the combination of sensors and other innovations described herein.

Street closures and other unusual conditions may also be detected, and utilized in providing information to users of the inventions.

In one aspect, video and still data may be gathered for the purpose of reporting to law enforcement, use in civil actions, or otherwise. In one aspect, video from a plurality of vehicles may be aggregated to show that a driver is driving in a manner consistent with somebody under the influence of drugs or alcohol. Such video made and forwarded, whether from one source or a plurality of sources, to a computer system that analyzes such data to determine the likelihood that the vehicle or the person driving the vehicle are in violation of the law. Similarly, the data may be required to exceed a certain threshold for computerized determination at which point it is reviewed by a live person.

In one aspect, it is critical to be aware of debris or hazards in the road. For example, a dead animal, spilled nails, a giant pothole, or ice are all very significant risks to the lives, health, and property of drivers. In one aspect, sensor data may be aggregated and utilized to identify road hazards. Such hazards may then be used to provide additional driving advice or parameters to driving assistance system such as a GPS system. Alternatively, or in addition, information about such hazards may be sent to a government or other entity capable of minimizing or removing those hazards. For example, the presence of a dead animal in the road may be reported to animal control, or the presence of a piece of furniture on a freeway may be reported to the Highway Patrol. Such reports are preferably done automatically.

Weather conditions, such as fog or heavy rain, can cause serious hazards. Such conditions may also be somewhat transitory, as would be the case with a thunderstorm cell that is moving at high speed through an area. In one aspect, it is difficult to determine the ground level impact based simply on radar data. In another aspect, for events like fog, existing radar and other technologies do not accurately reflect the risk to vehicular traffic on the ground. Data from various drivers, sensors and vehicles, and other sources may be utilized to identify weather hazards. Vehicles may be routed around such hazards, may be warned to slow down, or may simply be told that it is safer to be in the slower lanes. In addition, vehicles that are driving recklessly relative to the hazard may be identified, and drivers utilizing these inventions may be directed to take routes or be in lanes that avoid the risk of being hit by such drivers.

In one aspect, routing may be done based on likely impact on fuel efficiency, whether in whole or in part. For example, fuel efficiency on a newly paved road may be higher than on a poorly paved road. Further, certain roads and/or certain lanes may have been paved more recently than others, and result in better fuel efficiency. Such data may be used to guide drivers to the most fuel-efficient pathway, although in some instances it will be necessary to programmatically or algorithmically balance risk and fuel efficiency in making driving recommendations.

Although this document describes driving recommendations and instructions for drivers, it should be understood that the inventions are applicable to self-driving vehicles as well.

In one aspect as regards in particular electrical vehicles, but more generally any vehicle that does range predictions, one problem with range prediction is that vehicles do not incorporate elevation changes properly. For example, a vehicle climbing the grapevine portion of Interstate 5 freeway in California will experience a substantial increase in elevation, which results in a substantially higher use of fuel. If the range of the vehicle is predicted based on the past 10 miles, for example, after 10 miles on that portion of the freeway, the predicted range of the vehicle is essentially wildly inaccurate. The same problem occurs when heading down in elevation, where the predicted range of the vehicle is wildly inaccurate in the optimistic direction. The changes to elevation may be drawn from a map, GPS data from other vehicles, a combination of those, or other sources, and may be utilized to modify range predictions to be accurate even when the vehicle is climbing or descending on a road.

In one aspect, a system may be designed that identifies other vehicles as a friend, foe, or neutral. A vehicle that is presented as high risk may be designated as a foe, a vehicle that the system is readily familiar with as a safe driver may be designated as friend, etc.

It should be understood that one mechanism to implement certain aspects of the inventions is to have a centralized data repository, such as a server, that receives data from vehicular sensors, mobile devices, and other sources, compares them with driver preferences and driver history, and sends driving directions and/or recommendations to the vehicles.

While the instant application discusses drivers, it should be understand that in many instances, these inventions are applicable to automated driving systems functioning as (or assisting human) drivers.

### BRIEF DESCRIPTION OF THE DRAWINGS

FIG. 1 is a graphical representation of a road with several lanes of traffic traveling in the same direction and with a road hazard in one of the traffic lanes.

FIG. 2 is a graphical representation of a road with several lanes of traffic traveling in the same direction and showing vehicle onramps and off-ramps.

FIG. 3A is a graphical representation of a road with two semi-trucks in the right hand lane.

FIG. 3B is a graphical representation of a two-lane road with travel in both directions and a car that may attempt to pass a car in front of it.

FIG. 4 is a graphical representation of a road with a bus in the right hand lane, a bus stop, and a car that may change lanes.

FIG. 5 is a graphical representation of a windy road with ice across a section of the road.

FIG. 6 is a graphical representation of a road with a school bus traveling toward a school with several vehicles following the bus.

FIG. 7 is a graphical representation of parallel roads with vehicle and pedestrian traffic and buildings on both sides of the roadways.

FIG. 8 is a graphical representation of several roads with vehicle traffic, a school and a parking or bus area.

FIG. 9 is a graphical representation of a road with vehicle traffic and debris in the road.

FIG. 10A is a graphical representation of a road having a section that is flooded.

FIG. 10B is a graphical representation of the intersection of roads where one section of the road has snow that has not been plowed.

FIG. 11 is a graphical representation of several roads with one road having fresh tar, gravel along the side of the road and a fallen tree.

FIG. 12 is a graphical representation of a road with several traffic lanes travelling in the same direction with both motorcycle and automobile traffic.

### DETAILED DESCRIPTION OF THE PREFERRED EMBODIMENTS

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications, and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. These conventions are intended to make this document more easily understood by those practicing or improving on the inventions, and it should be appreciated that the level of detail provided should not be interpreted as an indication as to whether such instances, methods, procedures or components are known in the art, novel, or obvious.

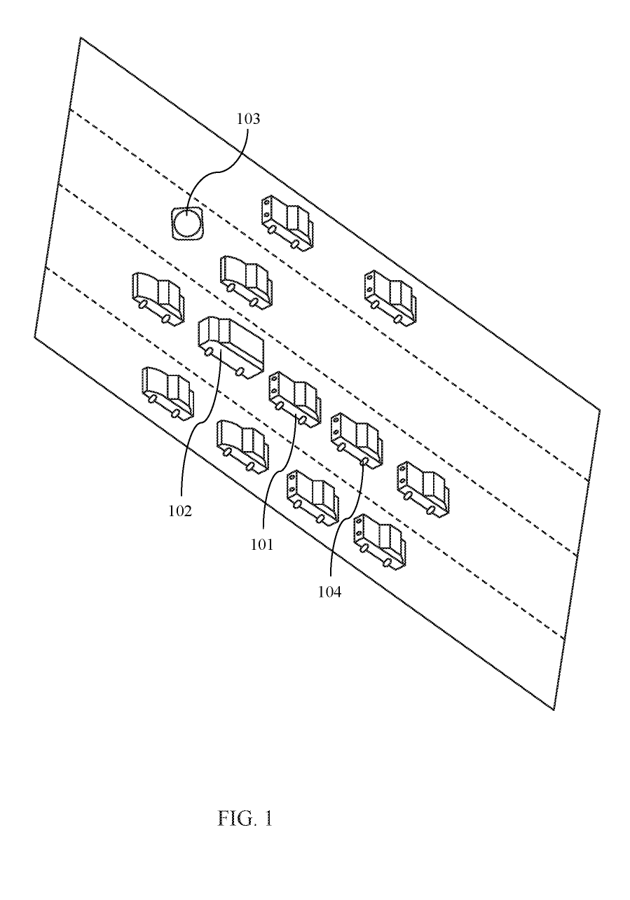

Turning to FIG. 1: A user's vehicle 101 is in traffic. Depending on vehicular height and other factors, vehicle 101 may not be able to see past a vehicle 102 in front (which may in some aspects be larger than vehicle 101). Similarly, vehicle 101 may not be able to see beyond vehicles to the right, left, or rear of vehicle 101. Similarly, depending on the configuration of vehicle 101, there may be blind spots and other obstructions. In some instances, certain vehicles have no side and/or rear windows. This leads to a lack of situational awareness and difficulty or inability to predict road hazards and/or conditions.

In one aspect, video, radar, and other signals relating to traffic and/or other factors impacting driving and/or safety may be transmitted to the user vehicle 101. For example, vehicle 102 may have a front-viewing camera and vehicle 104 may have a rear-viewing camera. Signals from one or more such cameras may be transmitted via a local signal and/or a network-carried signal and made available to other vehicles. In one aspect, the signal may be sent via a daisy-chained mechanism. Vehicle 101 may receive said signal. Said signal may be utilized to determine traffic patterns, to display the view on a display, or otherwise provide additional data to the driver and/or automated driving software operating vehicle 101. In one aspect, video from another vehicle and/or another video source, such as a stationary camera, may be utilized. More than one data source may be simultaneously utilized and in one aspect may be processed to generate a composite image. Video data may be displayed on a heads-up display, a wearable display, and/or projected onto the windshield in a manner that renders the other vehicles and/or other obstructions partially or fully transparent.

In one example, vehicles ahead of vehicle 101 may be rendered at 75% opacity, allowing the user to see through the vehicles or other obstructions. Taking the example further, there may be a road hazard 103 such as a spilled load of gravel. Normally, the driver of vehicle 101 would not be able to see the hazard 103 because vehicle 102 and other vehicles may block the driver's view of road hazard 103. Utilizing aspects of the instant inventions, the driver of vehicle 101 can see through the other vehicles and observe the road hazard, thereby avoiding potential risks such as changing lanes to be in the same lane as the road hazard 103, being unaware that other vehicles may swerve to avoid road hazard 103, or similar risks. Similarly, vehicle 101 may be unaware of rapidly approaching vehicles or emergency vehicles, but would receive that data utilizing the rear-viewing camera in vehicle 104.

In one aspect, the position of the driver's head and/or the direction or gaze of the driver's eyes may be utilized to properly position the data being projected on the windshield or otherwise displayed so that the appearance of semi-transparency is properly and/or accurately and/or understandably rendered. In another aspect, a virtual window may be displayed on other vehicles and a view of the area through the window may be displayed utilizing data that shows a visual depiction of at least a portion of the area in front of the vehicle on which the virtual window is displayed. Similarly, data may be displayed on side windows and/or the rear view mirrors.

In one aspect, the vehicle 102 in front of the user's vehicle 101 maybe rendered partially or fully transparent by utilizing displays (for example, OLED, flexible displays, LED, LCD) affixed to, or integral to, the vehicle 102. The displays are fed actual visual data gathered from cameras, modified visual data gathered from cameras but modified to show hazards in an exaggerated or easily distinguished way, to correct for aspect ratio and point of view errors, and otherwise, and/or visual data combined with sensor data converted to a visually perceptible mode. For pedestrian safety, in one aspect the front of the vehicle would not be rendered apparently fully transparent. In another aspect, an outline of the vehicle, or a semi-transparent depiction of the vehicle, is desirable in order to allow other vehicles to see that the semi-transparent vehicle is present. In addition to, or in place of, being semi-transparent (rather than apparently fully transparent), the vehicle may display line drawings indicating the edges of the vehicle, may display hatch marks, or otherwise indicate its presence visually.

In another aspect, it is desirable to minimize wind resistance and reduce the width of the farthest outlying portions of the vehicle. In many cases, the side mirrors are sources of wind resistance as well as being increasing the width of the farthest outlying portions of the vehicle. It is desirable to reduce the size of side mirrors or eliminate them entirely. In one aspect, a virtual side view mirror is projected on one or both of the driver or passenger side windows. In another aspect, instead of projection, the “mirror” may be a display integrated into the window or located elsewhere (preferably near the window). The data displayed on the virtual mirror would be generated by cameras. In one aspect, the cameras may be very low profile cameras located at approximately the location where the mirror would be placed. In another aspect, the image shown in the mirror may be a composite of data generated by one or more of front, side, or rear cameras, side, front or back sensors. It may further include data generated by other vehicles, such as video, dashboard data like speed, and sensor data (transmitted to the subject vehicle) and/or data generated by the subject vehicle, such as dashboard data.

In one aspect, the data gathered may be utilized to generate a virtual overhead view of the vehicles. In another aspect, an actual overhead view may be generated utilizing data from aerial cameras, “red light” cameras, or other sources. Such data may be displayed for the use of the driver.

In one implementation, a local signal may be sent from one vehicle to another in a daisy chain, so that the lead vehicle 102 sends a video signal to the vehicle 101 behind it, which in turn retransmits that signal to the next vehicle 104, and so on.

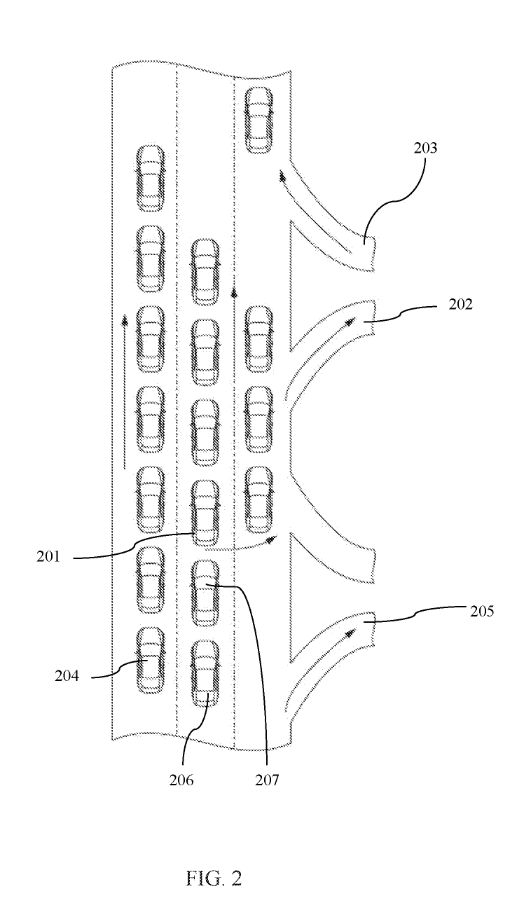

Turning to FIG. 2, it is frequently the case that a driver is unable to identify the best lane in which to travel. A vehicle 201 may desire to transit a road using the fastest lane. However, traffic does not always flow in the predicted “left lane fastest, right lane slowest” manner. For example, if it is morning rush hour and a freeway exit 202 leads to a place where many people are commuting to, there may be far more vehicles exiting at that exit 202 than getting on at the next onramp 203. As a result, traffic in the right lane may actually travel faster than traffic in the other lanes.

In one aspect, such video and other sensor data may be utilized to enhance the data available by traffic flow tracking systems such as that offered by Google by allowing the traffic to be measured not just on a road by road basis, but on a lane by lane basis. In one implementation, the lane-by-lane data is transmitted to a service provider such as Google, which may in turn retransmit the data to other vehicles or portable devices, whether or not the other vehicles are equipped with some, none, or all of the other inventions described herein.

The system may provide an indicator to the driver indicating which lane would be most efficient to drive in. In one aspect, destination information, as programmed into the GPS navigation system or otherwise, may be utilized to determine at what point the driver will need to be in the lane that turns into the exit lane. Such data may also be utilized in advising the driver. For example, traffic density may be utilized to determine the difficulty of changing lanes, and the predicted speed with which the lane changes may simply be made. The driver may be instructed to begin changing lanes at different distances from the exit depending on those and other factors.

In another aspect, a vehicle 204 may desire to exit at a nearby off ramp, but the system would analyze traffic density, speed, driver skill level, vehicle maneuverability, off ramp location and/or other factors to determine whether the vehicle 204 is capable of safely reaching the off ramp 205. If it is determined that the safety threshold is not reached, the vehicle may be routed to a subsequent exit, such as exit 202. GPS routing may be altered accordingly. For autonomous or semi-autonomous vehicles, such determination may additionally be made based on whether the vehicles 206 and 207 between the subject vehicle 204 and the desired off ramp 205 are capable of inter-vehicle communication and coordination. In the case, for example, that all of the vehicles are autonomously (or semi-autonomously) driven, their speeds and/or locations may be altered to permit the vehicle 204 to exit at the desired location 205.

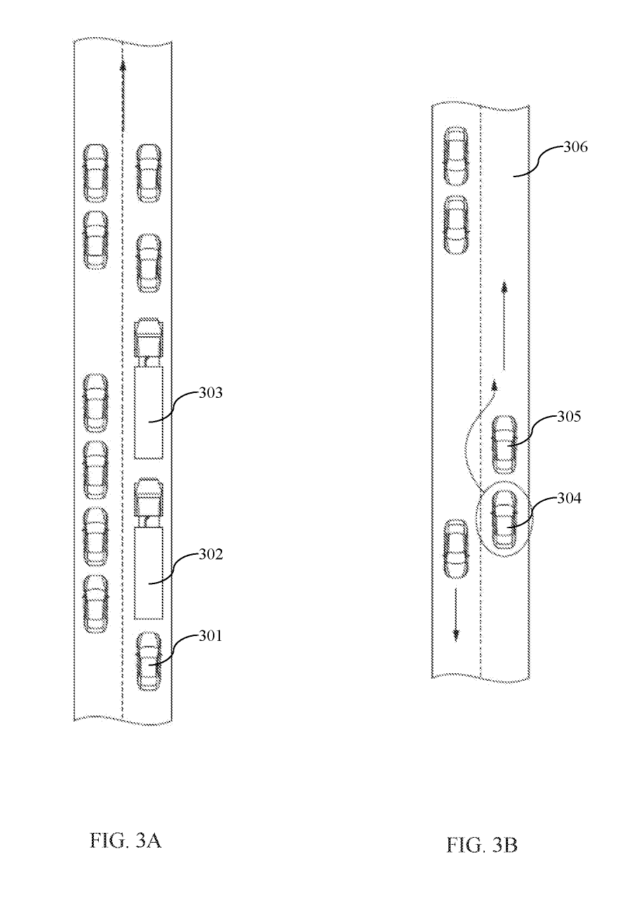

Turning to FIGS. 3A and 3B, it is often the case that a driver (e.g., the driver of car 304 of FIG. 3B) traveling on a two-lane highway must make a determination as to whether it is worth it to attempt to pass a vehicle (e.g. vehicle 305) in front of it by traveling for some distance in the oncoming traffic lane. In such a case, data about vehicles ahead may be utilized to inform or advise the driver as to the projected time savings, projected risk, and/or other benefits of passing.

Similarly, and as shown in FIG. 3A, a driver of a vehicle 301 must make a determination whether to pass a semi-truck 302 in front of the vehicle 301, when the driver cannot see past that truck. Using current technology, the driver would simply pass the semi-truck 302 and later learn whether the decision made sense when the driver observes whether or not there are additional slow trucks (e.g. semi-truck 303) and/or traffic ahead obscured by semi-truck 302. Utilizing the instant inventions, the system may provide indication as to the traffic speed and the amount of traffic ahead of the semi-truck 302.

In another aspect, a driver (e.g. a drive of vehicle 304) may be on a two-lane road for a large number of miles. The driver of vehicle 304 may be behind a vehicle 305 that is going slowly, and being unaware that 1 mile ahead, there are a dozen vehicles nearly bumper-to-bumper going even more slowly. In such a case, there is no benefit to passing the vehicle 305 immediately ahead of the driver 304, as that vehicle will rather quickly end up clumped in with the even slower vehicles ahead. Accordingly, the risk of passing that vehicle would be high relative to the benefit. In a contrary example, if there are no vehicles for 10 miles once the driver 304 passes the vehicle immediately ahead of her vehicle 305, benefits of passing would exceed the risks of passing.

In another aspect, there may be portions of a road (e.g. portion 306 of FIG. 3B) or driving environment that are associated with high levels of accidents, tickets, or other events. This data may also be incorporated into advice provided to the driver, or automated driving decisions.

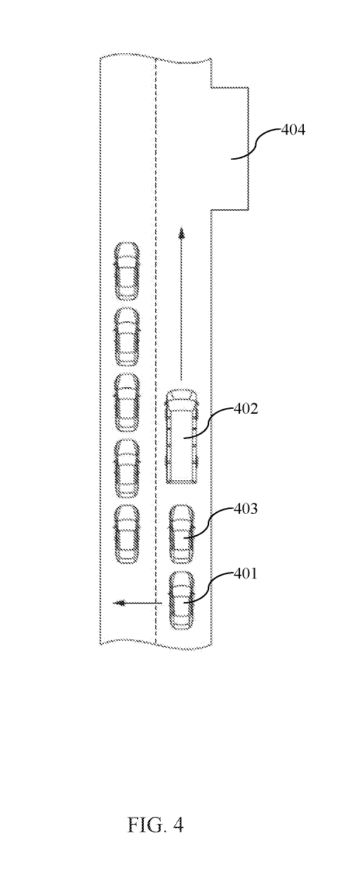

Turning to FIG. 4, it is a common experience that buses, trash trucks, UPS trucks, Federal Express or other delivery trucks, and other vehicles operate on a schedule. For example, the system may know that bus 402 will stop at bus stop 404. If the driver in vehicle 401, who may not be able to see the bus 402 because of the intervening vehicle 403, is in the same lane as the bus 402, the system may advise the driver (or the automated driving system may so behave) to change lanes to avoid being behind a stopped vehicle.

Similar information may be utilized regarding taxi stands or places that taxis frequently stop.

In addition, real time traffic disruptions may be identified utilizing the inventions. For example, a UPS truck may be stopped in a traffic lane, a taxi may be stopped dropping off a passenger, a food truck may be stopped, a panhandler may be walking in and out of traffic, or a bicycle may be moving slowly in a traffic lane. In such a case, real time or near real time data may be utilized to inform the driver of the obstruction and/or to advise the driver as to which lane to travel in. In one aspect, the data may be gathered from the vehicle causing the obstruction. In another aspect, the data may be gathered from other vehicles, stationary cameras, movements of GPS-bearing device such as smart phones, or other data sources.

In one aspect, published bus routes or similar routing information may be utilized to determine appropriate vehicle routing. For example, if a published bus route shows frequent bus stops on a particular road during a certain time period of a day, vehicles traveling on the road during the time period may be routed to an alternate road.

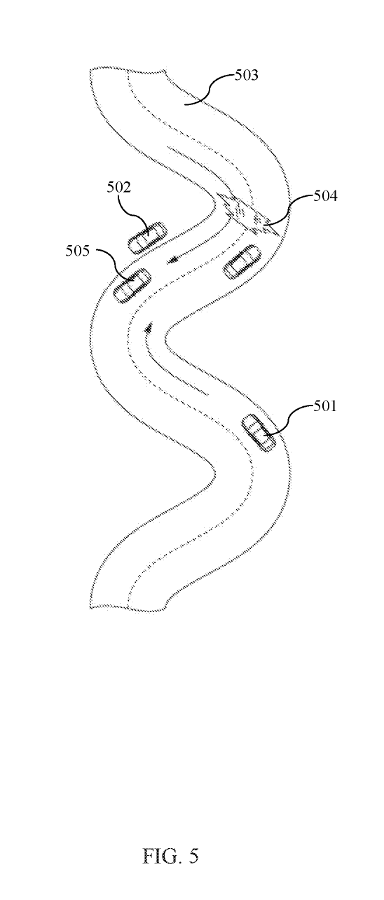

Turning to FIG. 5, it may be the case that a vehicle 501 is traveling on a road 503 and there is black ice or some other hazard 504. A vehicle 505 that had previously transited that area may have experienced spinning wheels, sliding, loss of traction, or other problems. The vehicle 505 may automatically transmit such information in a peer to peer manner to nearby vehicles, may transmit such information to nearby signs, which signs may display the warning (for example, a digital sign may receive a signal from a vehicle that it hit black ice 0.8 miles from the sign, and the sign may then automatically display the warning “black ice 0.8 miles ahead”), may transmit such information via a network connection, or otherwise. It should be understood that these various methods of transmitting information may be utilized in many of the aspects disclosed herein or in other portions of this specification.

There may also be a vehicle that has broken down, such as vehicle 502. Other vehicles (e.g., 505) that have passed vehicle 502 may image or otherwise observe the vehicle 502 broken down, and automatically transmit that information in one of the ways described in the preceding paragraph.

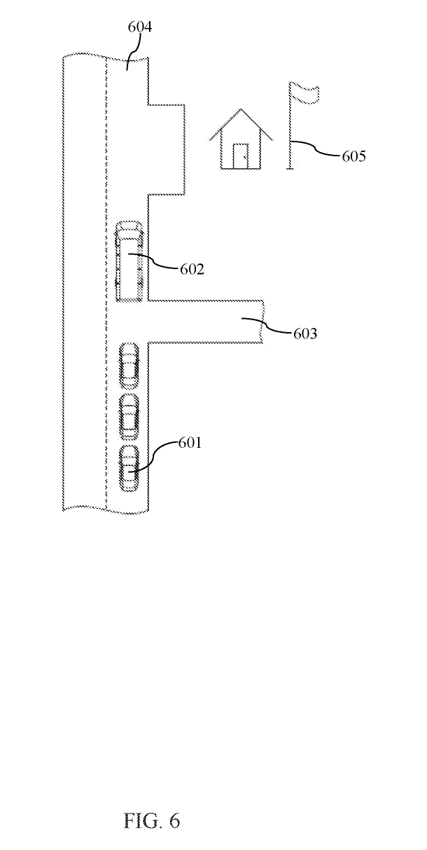

Turning to FIG. 6, we may utilize past data and/or make predictions based on characteristics observed about other vehicles, either alone or in combination with information about the area ahead, to advise the driver as to the best, or likely best, routing and/or to guide an autonomous or semi-autonomous vehicle. For example, vehicle 601 may be behind school bus 602 (with or without other intervening vehicles). Vehicle 601 may be following GPS routing that advises the vehicle 601 to continue straight on road 604. However, it may add one minute of travel time for vehicle 601 to go straight on road 604, and then make a right turn later. By observing the vehicle 602 is a school bus, that it is approximately the time that school starts, that road 604 is a two-lane road, and that a school 605 is located on road 604, the system may create a confidence score or otherwise determined that it is likely vehicle 602 will stop to let children on or off on road 604. Accordingly, the driving system may alter the routing and advise or cause the vehicle 601 to turn right on road 603, rather than making the right turn later.

While more data will sometimes be better, it is possible to make these predictions based on a small amount of data. For example, if vehicle 602 is a trash truck instead of a school bus, and we have observed vehicle 602 stopped to pick up trash on previous days and/or a database gathered by the vehicle 601 and/or by data received from other vehicles or sources, or even on this drive, when vehicle 602 turns right, or even signals right, vehicle 601 may be advised to route straight, continuing to travel on the road 604, turning right later.

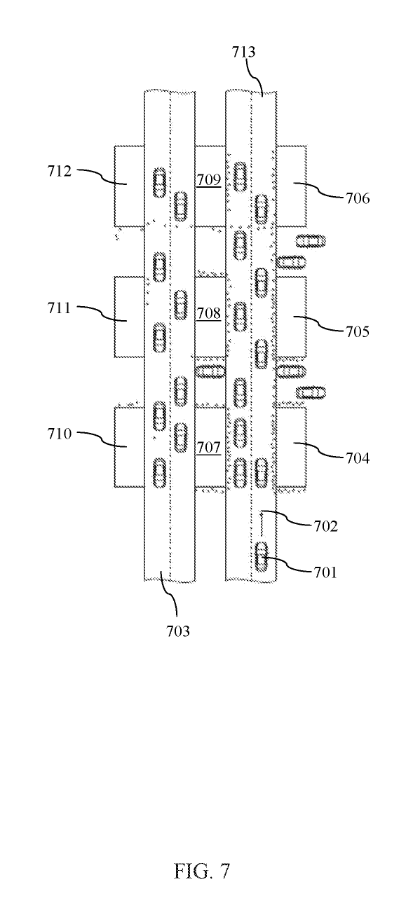

Turning to FIG. 7, it is often desirable to take a route with fewer hazards. In some instances, such a route may be faster; in other instances there may not be a speed difference; in yet other instances, the more dangerous route may actually be slower. If vehicle 701 desires to avoid pedestrian traffic, even though road 702 may, in other circumstances be the preferable route, the system they route the vehicle via road 703 in order to avoid the pedestrian traffic.

Furthermore, the nature of the facilities in an area, alone or in combination with the time of day, day of week, holiday status, or other factors may be utilized to determine predicted vehicular or pedestrian traffic and/or to determine whether vehicular or pedestrian traffic will behave in a particular way.

If buildings 704, 705, 706, 707, 708, 709 are restaurants, some or all of which serve alcohol and all of which exit onto a restaurant row 713, the system may utilize data from reservation systems, criminal or police records, past traffic data, real time traffic data, or other sources to determine routing. For example, pedestrian and vehicular traffic at 7 pm may be quite high and the system may route around restaurant row 713. At 11 pm, the risk of alcohol-impaired vehicles and pedestrians may be significantly higher, and the vehicle may indicate that a slower speed is appropriate, may drive a slower speed, and/or may route around restaurant row 713. In each case, it may identify businesses that are closed after 5 pm (e.g. 710, 711, 712) and route the vehicle 701 on a road 703 that houses those businesses.

In other instances, we may be concerned with a school or event letting out. When a school, stadium, theater, movies, sporting event or other event ends (or, in some instances, when it begins and/or when it is predicted that large numbers of people will depart at approximately the same time), there are significant traffic impacts. Data may be gathered from GPS, motion sensors, or other location or motion detection systems on mobile devices showing that a large number of people are in motion. Such data may be utilized to predict that a large number of people, whether in vehicles, on foot or otherwise, are likely about to leave a venue. Such information may be utilized to predict the need for taxi or other transportation services, rushes at restaurants, traffic impacts, public safety impacts, or other factors.

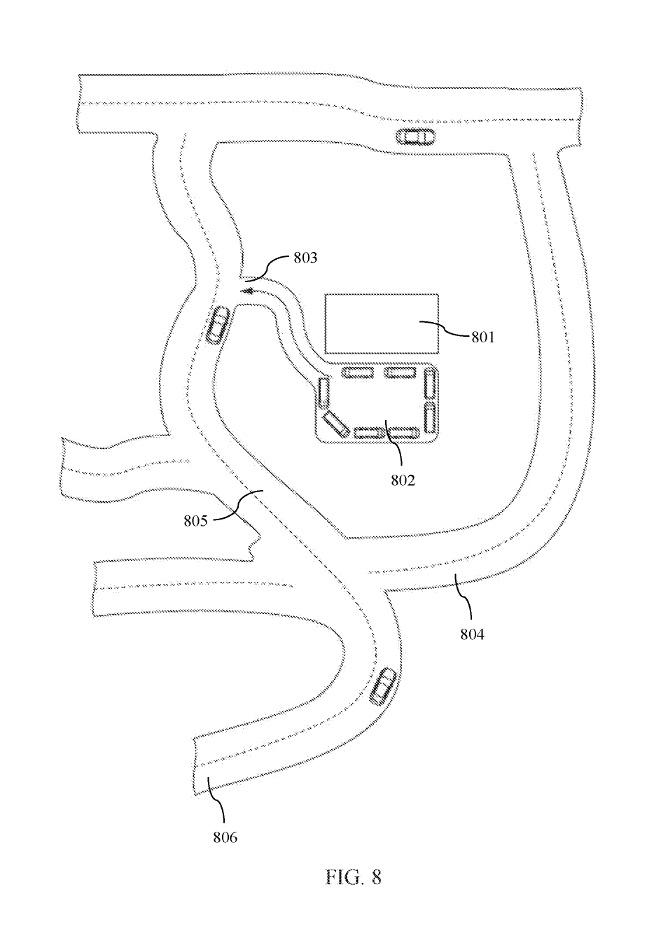

Turning to FIG. 8, there may be a public event venue 801, such as a sports stadium or a school, and/or a parking or bus area 802. Schedules and/or news feeds and/or social media may be utilized to determine when a populated event at such a venue or parking/bus area will let out, optionally together with an estimate of the number of people involved.

For vehicular systems, routing may be altered to avoid such crowds. For example, a vehicle may be approaching on a road 806 that has a fork, leading to a road 805 that passes the outlet 803 for the event and a road 804 that does not pass the outlet. In such a case, the vehicle may be routed on the faster route which may be 803 in the absence of an event and 804 in the presence of an event.

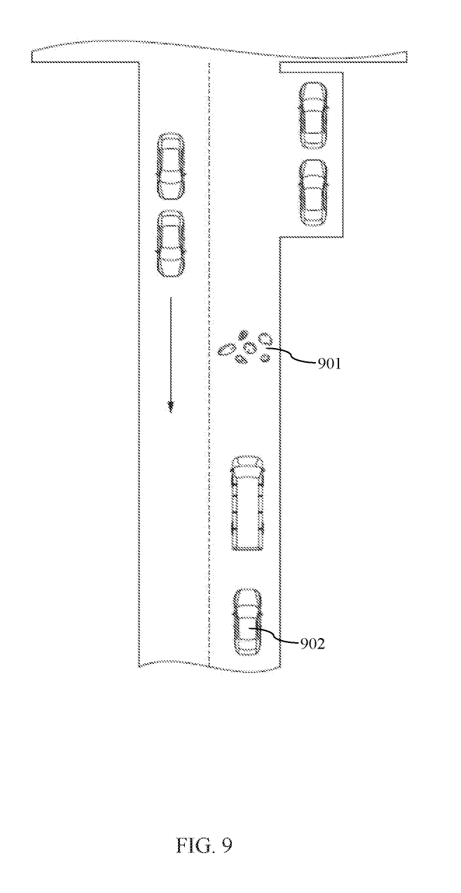

Turning to FIG. 9, there may be lawn debris or other road hazards 901. Such hazards may impair traffic flow, close a lane, or create other delays and/or hazards. The system may provide an advance warning, such as at to vehicle 902 at a location sufficiently ahead of such hazard 901 to allow the driver of vehicle 902 to exercise additional caution, slow down, and/or reroute.

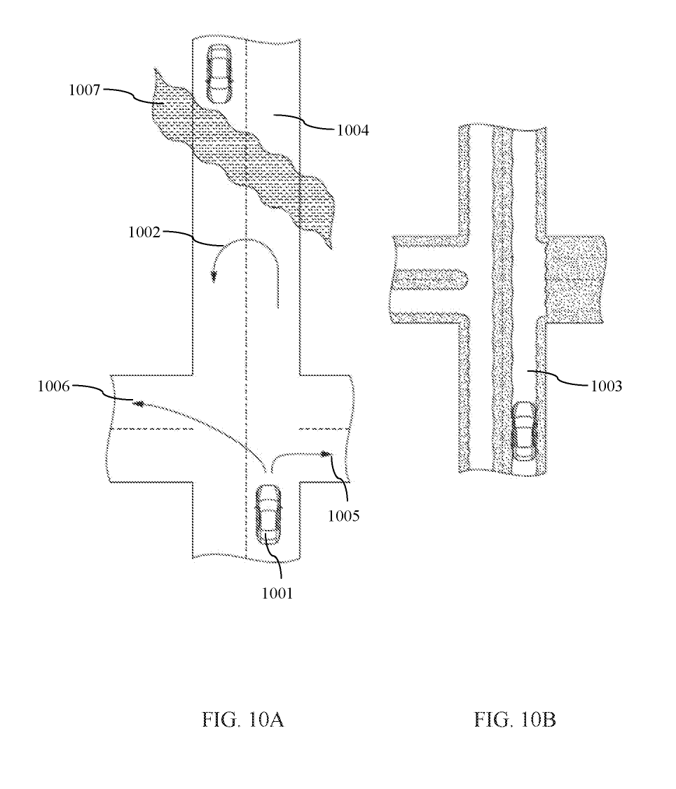

Turning to FIGS. 10A and 10B, traffic reporting systems, particularly those utilizing vehicle speeds, such as that offered by Google, may indicate that a road (e.g., 1003 of FIG. 10B) is not congested or that there is a lack of data. However, such indication may be because the road has not been plowed, so drivers are avoiding it. Data gathered via one or more of the methods described herein may be utilized to provide additional vehicular routing information.

Similarly, there may be a flooded area 1007 on road 1004 which is being avoided by other vehicles, making it appear that a road is open or empty of traffic. While this may appear on existing systems as a free flowing traffic area, or an area without traffic data, it is in fact an impassible area. By detecting that vehicles are avoiding the road, in one aspect as measured by vehicles making U-turns at a location 1002 near the impassible flooded area 1007, it is possible to provide improved routing data to drivers. For example, a driver of a vehicle 1001 may then take an alternative route 1005 or 1006 instead of continuing forward on road 1004 to the flooded area 1007.

In addition, historical data may be utilized to predict flood, snow and/or other hazard conditions. For example, if a part of the road 1004 floods 80% of the time when there is more than 1 inch of rain in a 36 hour period, it may be marked as flooded or a confidence score generated relating to flooding and/or closure and/or difficulty in transiting, and such information may be utilized for routing purposes.

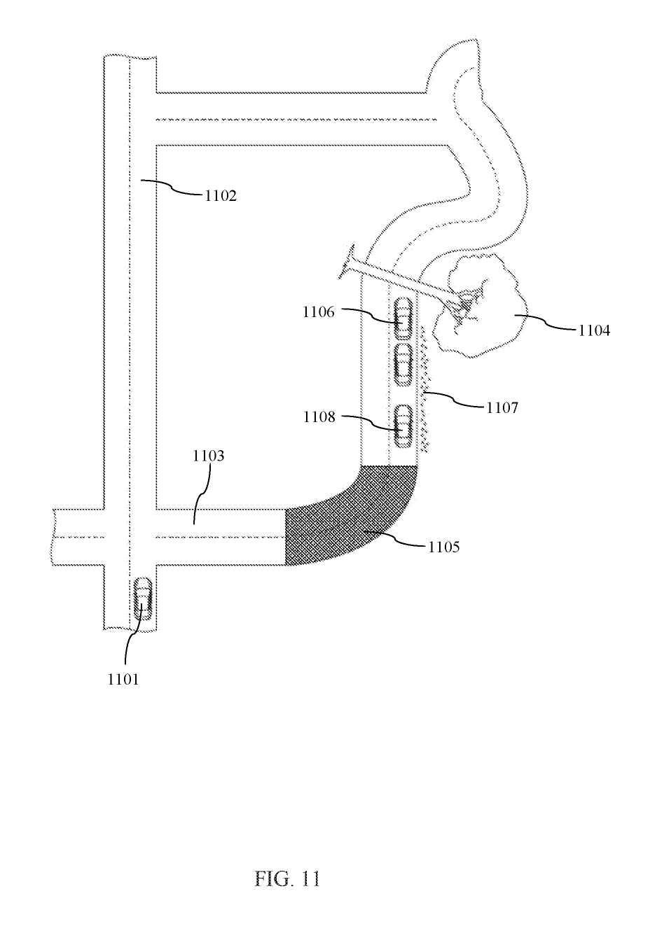

Turning to FIG. 11, poor quality roads, potholes, bad shoulders, stones or tars, downed trees or other hazards are a concern. In one aspect of the inventions, the amount of clearance required to safely transit a hazard may be calculated (with a confidence score in one implementation). For example, a sports car with a low suspension may be routed around an area where there is a potential for stones on the road (e.g., when stones 1107 are on or near the road 1103) or damage to the undercarriage of the sports car (e.g., when the road 1103 has fresh tar 1105), while an SUV with high suspension may not be rerouted. Similarly, a vehicle 1101 with variable suspension may automatically raise suspension of the vehicle, whether based on data as described herein or based on data generated by the vehicle itself.

In a further aspect, imagine that a vehicle 1101 is on road 1103, and a tree 1104 has fallen across the road. A vehicle 1106 stops, and the person gets out to clear the tree. To standard traffic tracking systems, this looks like a single vehicle 1106 has pulled over to the side of the road. However, this is actually an indication of a substantial obstruction. Such data would be captured by said sensors in the car that pulled over 1106, shared with other vehicles such as vehicle 1101, 1107, 1008, and utilized for routing purposes, and/or presented to the driver of vehicle 1101 for consideration and/or utilized by an autonomous or semi-autonomous system to change routing.

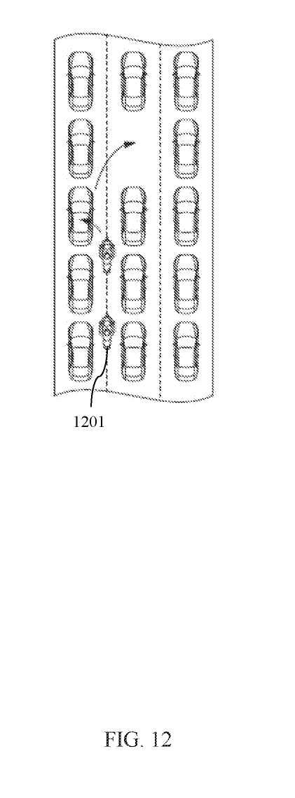

Turning to FIG. 12, it is common that motorcycles 1201 weave in and out of non-motorcycle traffic. The system may notify the motorcycle driver of the risk of other vehicles moving into the space the motorcycle is occupying or about to occupy (for example, by having a car change lanes). It may also notify the car driver that the motorcycle is present.

The foregoing descriptions of specific embodiments of the present invention have been presented for purposes of illustration and description. They are not intended to be exhaustive or to limit the invention to the precise forms disclosed. Obviously, many modifications and variations are possible in light of the above teaching. The embodiments were chosen and described in order to best explain the principals of the invention and its practical application, to thereby enable others skilled in the art to best utilize the invention and the various embodiments and modifications as are suited to the particular use contemplated. It is intended that the scope of the invention be defined by the components and elements described herein and their equivalents.

What is claimed is:

1. An autonomous driving vehicle, comprising:
at least one communications module, the communications module configured to receive external data from sources other than the vehicle, wherein the external data is data that cannot be gathered utilizing sensors affixed to the vehicle at substantially a time of external data receipt;
at least one processor analyzing the external data, either alone or in combination with data generated by the vehicle and/or sensors affixed to the vehicle;
wherein the driving behavior of the vehicle is altered based on the analyzing.

2. The vehicle of claim 1, where the external data is generated by at least one second vehicle.

3. The vehicle of claim 1, where the external data is generated by analysis of news feeds and/or social networking posts.

4. The vehicle of claim 1, where the external data comprises data about previously observed behavior of other vehicles.

5. The vehicle of claim 1, where the external data comprises data about the second driver of at least one other vehicle and the second driver is identified utilizing facial recognition.

6. A vehicle equipped with a regenerative braking system, comprising:
at least one sensor capable of determining the location of one of a stop sign, stop light, or final destination;
at least one processor receiving and analyzing sensor data to determine the likelihood that the vehicle will need to stop and the likely location at which such stop will take place;
wherein the at least one processor causes the vehicle to initiate regenerative braking at a location sufficiently distant from a projected stopping point so as to maximize an amount of energy generated by the regenerative braking.

7. The vehicle of claim 6, where the sensor data includes whether there are switches that actuate a switch causing a stop light to turn green, and further includes whether at least one of the switches have been actuated or is likely to be actuated prior to arrival of the vehicle at the switches.

8. The vehicle of claim 7, where the vehicle approaches the switches at a faster rate if the switches have not been actuated and are not likely to be actuated prior to arrival of the vehicle at the switches.

9. The vehicle of claim 8, where the vehicle accesses at least one calendar appointment of a person in the vehicle, and approaches the switches at a faster rate only if it appears, beyond a set threshold, that the vehicle will arrive late or nearly late to the appointment.

10. A vehicle, comprising:
a system for adjusting vehicle settings based on data about preferred settings for a driver;
a connection to a storage medium storing preferred settings for the driver, the storage medium not permanently attached to the vehicle;
a processor reading data from the storage medium;
wherein the system adjusts vehicle settings based on data in the storage medium.

11. The vehicle of claim 10, wherein the storage medium is a USB key.

12. The vehicle of claim 10, wherein the storage medium is a mobile device, and the data in the storage medium is obtained by a network or near field connection to the mobile device.

13. The vehicle of claim 10, wherein the storage medium is encrypted so that it may not be accessed without entry of a passcode by the driver.

14. The vehicle of claim 10, wherein the storage medium is not accessible unless an authorization signal from a portable device is received.

15. The vehicle of claim 11, wherein the storage medium is not accessible unless a near field computing signal is received by the vehicle.

16. The vehicle of claim 10, wherein the data is not retained by the vehicle once the storage medium is no longer operably connected to the vehicle.

17. The vehicle of claim 10, wherein the data is not retained by the vehicle longer than a set time after the storage medium is no longer operably connected to the vehicle.

18. The vehicle of claim 10, wherein the data is not accessible unless authenticated by a face, fingerprint, or other biometric data.

19. The vehicle of claim 10, wherein the storage medium is a database and the data is not specific to a given driver, but rather associated with drivers having at least one common characteristic.

20. The vehicle of claim 10, where the storage medium is a database and the driver is required to sign in to access the data base.
